(19) United States
(12) Patent Application Publication
(10) Pub. No.: US 2007/0037643 A1
(43) Pub. Date: Feb. 15, 2007

(54) Variable circumference sprocket

(76) Inventor: Andrew E. Briesmeister, Yakima, WA (US)

Correspondence Address: ROBERT L. SHAVER;DYKAS, SHAVER & NIPPER, LLP, PO BOX 877, BOISE, ID, 83701-0877, US

(21) Appl. No.: 11/200,797

(22) Filed: Aug. 9, 2005

(51) Int. Cl. F16H 55/00; F16H 55/46

(52) U.S. Cl. 474/47; 474/95

(57) ABSTRACT

The invention is a sprocket which is variable in circumference, in order to allow a large diameter sprocket to be driven by or to drive a chain. The sprocket is made up of a hub, a number of spokes, and rim sections. Adjustment brackets on the spokes allow some of the rim sections to move in and out, away from the center of the hub, and thus allow the sprocket to vary its circumference in order to make adjustment for length changes in the chain due to wear of the individual chain components.

### BACKGROUND OF THE INVENTION

### Field of the Invention

The present invention generally relates to sprockets, and more particularly to sprockets which have a variable circumference.

Using a roller chain is a very efficient manner of transferring energy from a motor to rotating machinery. In many situations, the chain is the ideal solution for power transmission. However, there are problems with using a chain for this purpose. A roller chain is composed of a number of plates, pins and rollers which are connected to each other. The tolerance between these pieces may be very small when the chain is new. However, as the chain wears, the tolerance at each piece of each link increases. When a chain becomes worn, there may be considerable build up of tolerance in the length of the chain. This problem is compounded when the chain is a long one. This becomes a problem when a large circumference sprocket is to be driven by an equally long chain. With a long chain, the build up in the tolerance in all of the units makes it so that the chain becomes longer than planned for. A sprocket typically has a number of teeth around its circumference which interact with the chain. The distance between the points of each tooth of the sprocket is the pitch. As the sprocket wears, the pitch between each tooth on the sprocket does not change. However, the distance between each of the rollers of the chain does change. When the difference between the pitch of the teeth and the distance between rollers becomes significant enough, the chain will tend to hop off the teeth, and not settle into the valleys between the teeth. At this point, power transmission becomes highly inefficient, and the power transmission system basically destroys itself and its components through this problem of chain wear.

What is needed is a drive system in which a long chain can be utilized around a large circumference sprocket in order to transmit energy to machinery. Although the circumference of the sprocket needs to be a variable, this sprocket has to accommodate a chain in which the distance between each link does not change very much, but in which cumulatively the distance between one link and another may increase greatly as the chain wears.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other goals are achieved by the variable circumference sprocket of the patent. This sprocket is configured for engagement with a chain, and is particularly adapted for operation as a large diameter sprocket engaging a long chain. The drive sprocket includes a sprocket body which is configured to rotate around an axis of rotation. The sprocket body includes a sprocket rim which is variable in circumference. The sprocket rim is located on the periphery of the sprocket body, and it is made up of a number of toothed sprocket sections, separated by areas of the sprocket rim which do not contain teeth. These areas may be referred to as chain support sections, or as non-tooth sections. The chain support sections can be configured in a number of ways to contain and support the chain which the sprocket is made to interact with. The chain support section may be in the shape of a U-shaped channel, in which the chain is enclosed in the bottom of the U. The chain support section may also be a ridge which supports the inside of the chain rollers, and does not have sides like a channel.

The variable circumference sprocket is variable by moving one of the components of the sprocket rim either away from or towards the axis of rotation. Thus, either one or more of the toothed sprocket sections can be moved away from or towards the axis of rotation, or one or more of the chain support sections, or non-toothed sections, can move away from or towards the axis of rotation. By moving at least one of these components in relation to the axis of rotation, the circumference of the sprocket is changed to account for the chain lengthening with wear.

The toothed sprocket sections contain at least one tooth, and typically would contain one to five teeth. Each of the teeth in one section of sprocket would be set at a fixed pitch relative to each other.

The chain support sections can be made up of a number of sprocket rim sections. Each sprocket rim section would have a first end and a second end. One or both ends, but preferably the first end, would be an end which is fixed to the sprocket body in a manner that allows it to rotate. One or both ends, but preferably the second end, is also fixed to the sprocket body, in a manner which allows it to move in and out away from the axis of rotation. Alternatively, both ends of the sprocket rim sections may be adjustable, so that both ends may move from or towards the axis of rotation. The toothed sections of the sprocket rim may be attached to the sprocket rim sections, such as at one end or the other. The toothed sections can also be attached to the sprocket rim sections anywhere along the length of the sprocket rim sections.

One manner of configuring the sprocket rim sections is to position the sprocket rim sections so that adjacent sprocket rim sections have their second ends mounted next to each other. In this way the two second ends of two sprocket rim sections would be configured to move together in a direction either from or towards the axis of rotation. The toothed sprocket sections may be positioned on the sprocket rim sections, or adjacent to the sprocket rim sections, next to the first end or the second end or both ends of the sprocket rim sections.

The sprocket body may further comprise a hub, with a number of spokes attached to the hub and extending out to the sprocket rim, thus forming the sprocket body. In one configuration of the device, some of the toothed sections are attached to a spoke, with at least some of the toothed sections configured for variable movement along the spoke towards or away from the hub. The toothed sections can be configured so that alternating toothed sections, in other words, the toothed sections attached to every other spoke, are configured for adjustment of position relative to the hub. Preferably, the toothed sections adjust position by moving away from or toward the hub, thereby changing the circumference of the sprocket. By moving the toothed sections away from the hub, the circumference of the sprocket changes without changing the pitch between the teeth of the toothed sections.

In another configuration of the device, the toothed sections are mounted on spokes or on the sprocket rim, in a manner that is stationary, while the non-toothed sections are mounted to the spokes or the sprocket rim in a manner that allows them to be adjusted towards or away from the axis of rotation of the sprocket.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a plan view of the variable sprocket of the invention with an associated drive system.

FIG. 2 is a plan view showing more detail of certain parts of the variable circumference sprocket.

FIG. 3 is a plan view showing details of a variable circumference sprocket.

FIG. 4 is a plan cross-sectional view of the sprocket, showing a toothed section.

FIG. 5 is a plan cross-sectional view of the sprocket with a toothed section attached to a rim section.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

There are many situations in which it is preferable to use a chain to drive a large circumference sprocket. This can be desirable because a chain and motor can efficiently drive a large circumference sprocket. Driving a large circumference sprocket with a chain is very efficient in weight, space and cost. To drive a rotating machine using a motor and gears only, a heavier framework structure is required, as is a heavier gearbox. For example, to drive a large diameter sprocket with a chain and motor that rotates at 20 rpm, so that the sprocket rotates at ½ rpm, requires a 200 lb gearbox, which costs approximately $1,200. To drive the same sized machine using gears at that rpm would require a 12,000 lb gearbox, which costs approximately $20,000. In the above, the 12,000 lb gearbox would be approximately 4 feet tall versus the chain and sprocket system, which would be approximately 3 inches tall. Thus, driving a large machine with a gear system is more expensive, and results in a system which is much larger and heavier. If a large circumference sprocket can be driven by a small motor however, by use of a long chain which goes around the circumference of a large sprocket, efficiencies in weight, size, space and costs are achieved.

The problem with a large sprocket with teeth that are a fixed distance or pitch, is that as the chain wears, the chain elongates with wear. It has been found that a sprocket with more than about 80 to 96 teeth begins to have serious problems in the accumulated error of tolerance plus wear build up in the chain. If a sprocket is desired which has 200 teeth, hypothetically, then it would become impossible to drive that sprocket with a chain as the chain wears. When the length of error build-up in the chain reaches a certain point, the chain would start hopping, and the drive mechanism would become very inefficient at best, and possibly destructive of machinery. For this reason, as the size of the sprocket is increased, and the number of teeth on the sprocket are increased, there is decreased tolerance for error and wear build-up in the system.

The purpose of the invention then is to enable a long chain to drive a large circumference sprocket without the problems usually associated with such a system due to the characteristics of chain wear and tooth interaction. This goal is accomplished by the variable circumference sprocket of the invention and the chain drive assembly of the invention. These provide a variable circumference sprocket to compensate for wear in the chain, while at the same time using teeth which are at a fixed pitch and yet which interact with accuracy with the rollers of the chain.

The variable circumference of the sprocket of the invention, and the drive assembly of the invention, can be sized to any number of different configurations, but it is envisioned that a sprocket of greater than approximately 95 teeth or pitches would greatly benefit from such a system, and a sprocket with greater than 200 pitches could be operated by such a sprocket. A large circumference drive sprocket may be desirable in any number of drive systems. One specific system in which this drive system has proven valuable, is a system in which the drive sprocket is attached to the edge of a vertically oriented cylindrical drum. The purpose of the drive sprocket is to turn the entire drum. One use of turning such a drum would be when the drum itself is a pulley for a conveyor belt. In certain food processing situations, a cylinder such as that described is the pulley for a conveyor belt, with the conveyor belt arranged in a spiral configuration, with one edge of the belt touching the drum. The conveyor belt is thus a helical conveyor, and conveys materials on the top surface of the belt.

A system using a drum as a pulley for a conveyor belt is described as an example of a preferred embodiment, realizing that the embodiment described is equally applicable to any application using a large circumference sprocket which is utilized to transmit power.

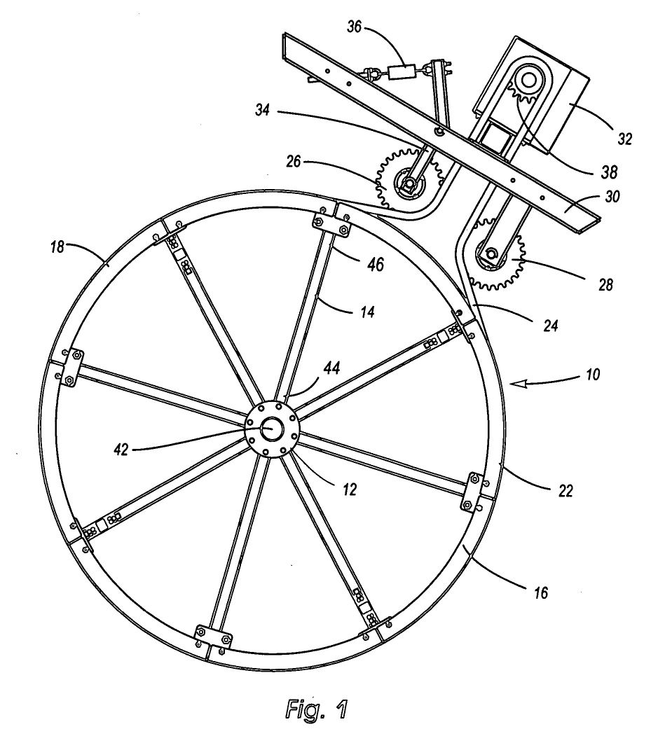

A preferred embodiment of the sprocket assembly of the invention is shown in FIG. 1 and includes a frame 30 on which various components of this system are mounted. Obviously the frame 30 could be of any number of sizes and configurations, but one that is suitable is a frame made of steel structural tubing, approximately four inches tall and four inches wide. On the frame is attached a motor 32 which also includes a gearbox which would be sized appropriately for the desired RPM's of the sprocket. The motor 32 includes a drive motor sprocket 38 on which is mounted a chain 24. The chain 24 extends around the drive motor sprocket 38, and also around the entire circumference of a variable circumference sprocket 10.

In the system shown in FIG. 1, a first guide sprocket 26 and a second guide sprocket 28 are mounted to the frame 30 and control the path of the chain 24 from the drive motor sprocket 38 to the variable circumference sprocket 10. By use of these guide sprockets 26 and 28, more of the circumference of the sprocket 10 is held in contact with the links of the chain 24. One optional configuration of the sprocket assembly is for one or more of the sprockets 26 or 28 to be biased in order to take up slack in the chain 24 and to also allow some movement in the path of the chain. This can be accomplished by a sprocket arm 34 as shown in FIG. 1, which is attached to the frame 30 by a spring 36. In one embodiment of the invention, the motor would be a 3 horsepower motor, utilizing a gearbox with a ratio of 87 to 1, a drive motor sprocket 38 of approximately 9 inches in diameter, with first guide sprocket 26 being approximately 7 inches in diameter and a second guide sprocket 26 being approximately 7 inches in diameter. In this particular embodiment, the variable circumference sprocket 10 is approximately 78 inches in diameter.

The chain for the example used in this embodiment, is a roller chain with a length of 312 inches, composed of approximately 250 links. Approximately 190 of these chain links are positioned around the circumference of the variable circumference sprocket 10 and engaged with teeth on the variable circumference sprocket 10. Although a roller chain is used by example, other types of chains would also fall within the claims and concept of the invention.

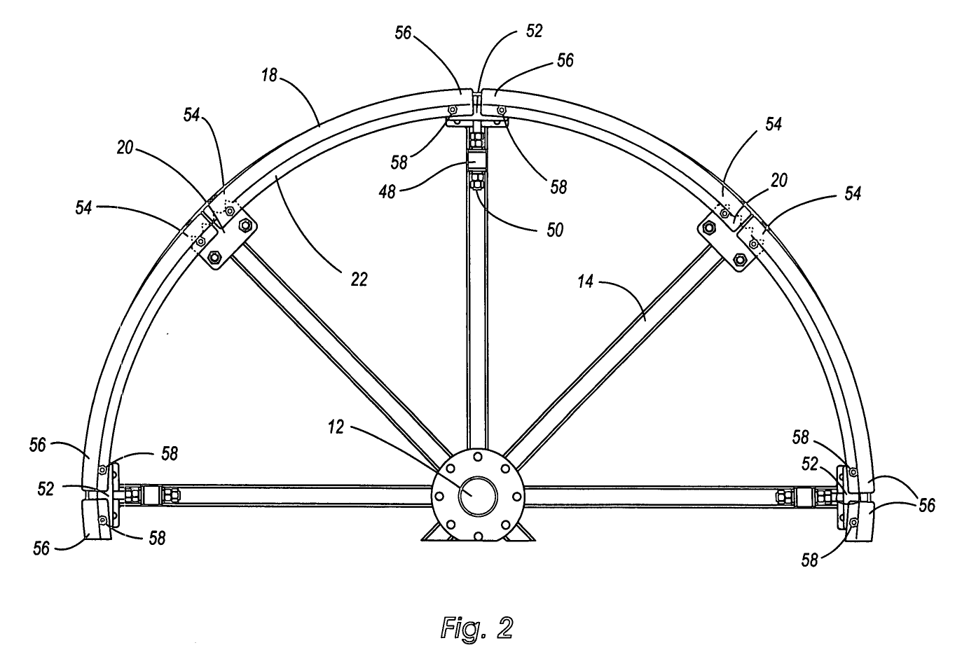

The variable circumference sprocket 10 includes a sprocket body 22 made up of a hub 12 to which are attached a number of spokes 14. The hub 12 rotates around an axis of rotation 42 which is an imaginary line which passes through the center of the hub 12. The spokes 14 include a first end 44 which is attached to the hub 12 and a second end 46 which is attached to rim 16 preferably made up of rim sections 18. The rim sections 18 are better seen in FIG. 2. Although spokes are called out in certain claims and in the preferred embodiment, the invention could equally function without spokes, with the sprocket body being in the form of a disk or wheel.

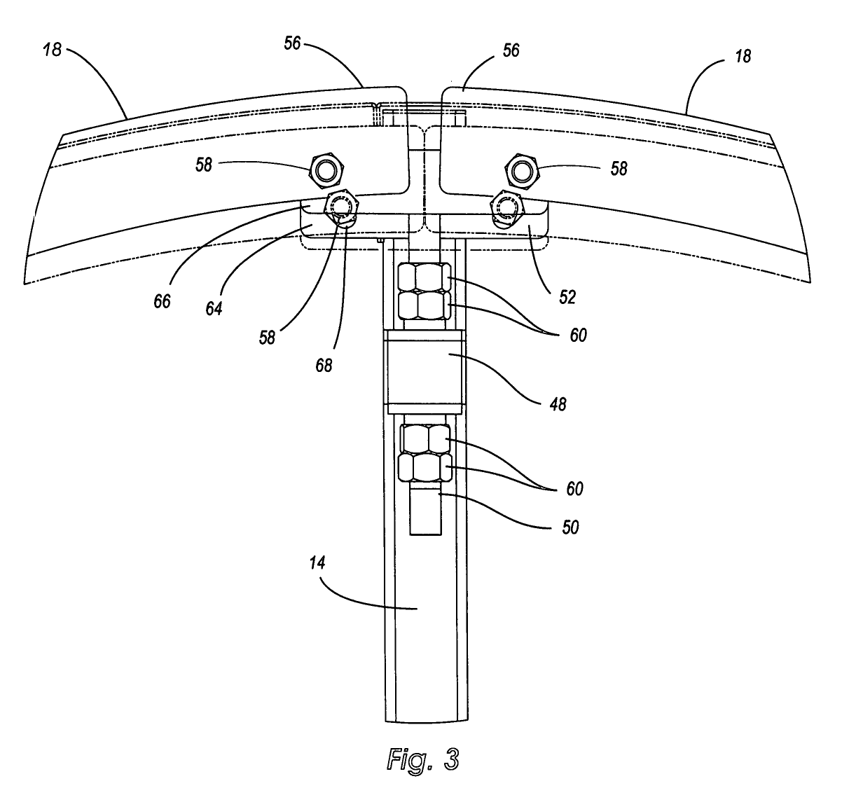

FIG. 2 shows more details of the spokes 14 and the rim sections 18. Attached to certain spokes 14 is an adjustment bracket 48 which is shown in more detail in FIG. 3. The adjustment bracket 48 includes an adjustment bolt 50 which adjustably passes through the adjustment bracket 48. On one end of the adjustment bolt 50 is attached an adjustment plate 52. The variable circumference sprocket 10 of this particular configuration is made up of 8 separate rim sections 18. Each of those rim sections 18 has a first end 54 and a second end 56. The second end 56 of one rim section 18 is attached to the adjustment plate 52, as is a second end 56 of an adjacent rim section 18 as shown in FIG. 3. Adjustment plate 52 includes slots 68 through which a rim section bolt 58 is used to attach the rim sections 18 to the adjustment plate 52.

FIG. 3 shows the adjustment plate 52 in a first position 64, in which the ends 56 of the rim sections 18 are closest to the hub, and a second position 66, in which the ends 56 of the rim sections 18 are pushed further away from the hub 12. By moving the adjustment plate away from the hub, the effective circumference of the variable circumference sprocket 10 is increased, and the sprocket assembly can be adjusted to take up the slack which accumulates in a chain that is showing wear. By traveling in slot 68, the rim section bolts 58 can secure the ends 56 of the rim sections 18 in either the first position 64 or the second position 66 or intermediate positions. Although a manual means of adjusting the rim sections 18 between the toothed sections 20 is shown, it can be seen that an automated adjustment mechanism would be achievable, and falls within the concept of the invention. For instance, a linear actuator would serve to adjust the position of the ends of the rim sections 18.

In the configuration of the preferred embodiment shown in these figures, there are 8 spokes 14 and every other one of those spokes 14 includes an adjustment bracket 48. There are 4 toothed sprocket sections, mounted on alternating spokes, each with 5 teeth. There are 4 adjustment brackets with the capability of moving the rim sections away from or towards the hub. Other configurations would be possible with an adjustment bracket 48 on each spoke, or with fewer adjustment brackets than what is shown. In the preferred embodiment, the adjustment bracket 48 is approximately 2 inches wide and 3 inches long, and the adjustment bolt 50 is a bolt approximately 0.75 inches in diameter and 6 inches long, and is secured by one or more adjustment nuts 60.

In the preferred embodiment, the toothed sprocket section 20 is attached to a spoke 14, and is not adjustable. However, on every other spoke between the toothed section 20 is an adjustment plate 52, which can move in and out away from the hub and thus, change the affected circumference of the sprocket 10. This preferred embodiment is shown in FIGS. 1-3. Each of the teeth of the toothed section is called a sprocket tooth, and collectively are referred to as sprocket teeth.

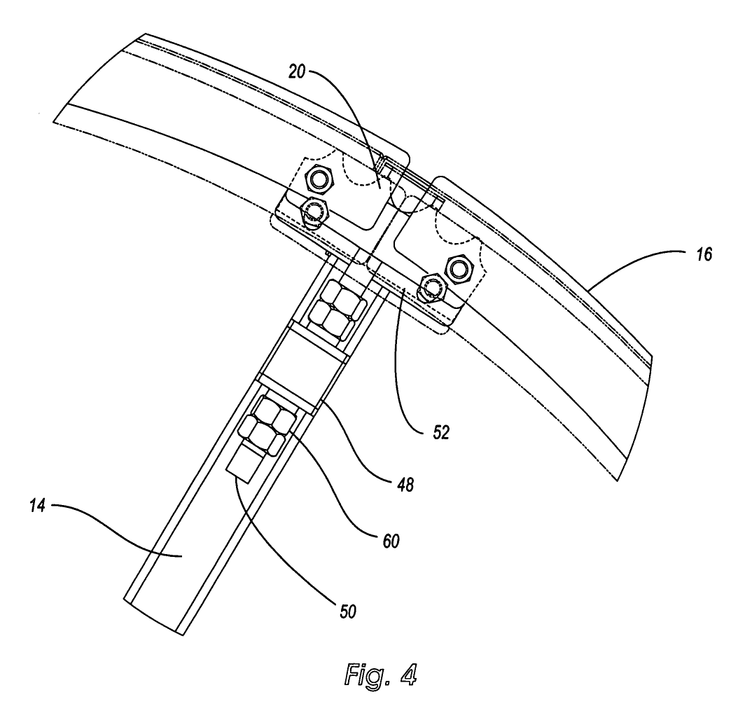

FIG. 4 shows another possible configuration, in which the toothed section 20 is attached to or part of an adjustment plate 52 which is adjustable in its spacing from the hub 12. Alternative configurations of the sprocket 10 can include any combination of toothed sections and adjustment plate 52. For instance, every spoke of the sprocket body 22 can include a toothed section 20 as shown in FIG. 4. Alternatively, every other spoke 14 could include a toothed section as shown in FIG. 4.

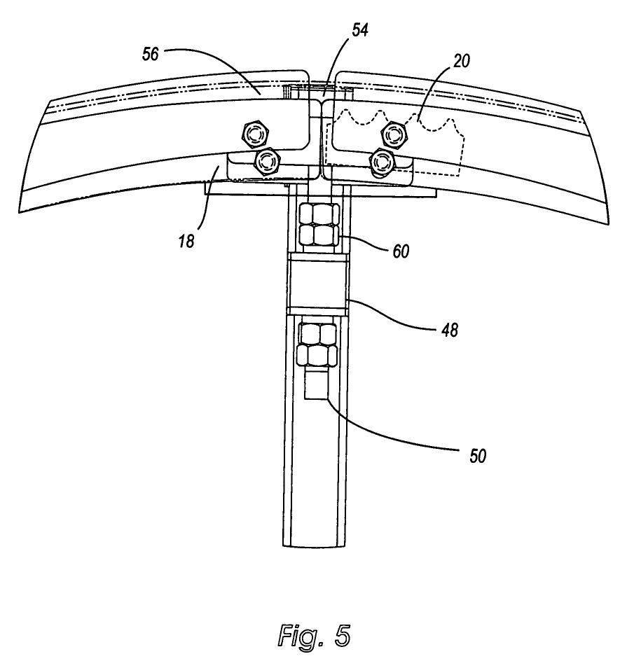

FIG. 5 shows an alternative configuration of the sprocket 10, in which the toothed section 20 is attached to a rim section 18, and moves in and out with the rim section 18. As with other embodiments, this could be on every spoke, could be on every other spoke, or could equally well be placed on a sprocket in which the sprocket body is a solid disc rather than one containing spokes.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A variable circumference sprocket for engagement with a chain, comprising:
a sprocket body configured to rotate around an axis of rotation;
a variable circumference sprocket rim, on the periphery of said sprocket body, comprising a plurality of toothed sprocket sections, each separated by chain support section; wherein said variable circumference sprocket rim is variable in circumference by moving either or both of one or more of said toothed sprocket sections away from or towards said axis of rotation, or by moving one or more of said chain support sections away from or towards said axis of rotation, with said adjustment in circumference to account for chain lengthening with wear as well as initial fit and engagement.

2. The variable circumference sprocket of claim 1 in which said sprocket rim is variable in circumference by adjustment of position or one or more of said toothed sprocket sections.

3. A variable circumference sprocket for engagement with a chain, comprising:
a sprocket body configured to rotate around an axis of rotation;
a variable circumference sprocket rim, on the periphery of said sprocket body, comprising a plurality of toothed sprocket sections, each separated by chain support section; wherein said variable circumference sprocket rim is variable in circumference by moving one or more of said toothed sprocket sections away from or towards said axis of rotation.

4. The variable circumference sprocket of claim 1 in which said sprocket rim is variable in circumference by adjustment of position or one or more of said chain support sections.

5. A variable circumference sprocket for engagement with a chain, comprising:
a sprocket body configured to rotate around an axis of rotation;
a variable circumference sprocket rim, on the periphery of said sprocket body, comprising a plurality of toothed sprocket sections, each separated by chain support section; wherein said variable circumference sprocket rim is variable in circumference by moving one or more of said chain support sections away from or towards said axis of rotation, with said adjustment in circumference to account for chain lengthening with wear as well as initial engagement when new.

6. The variable circumference sprocket of claim 1 in which said toothed sprocket sections comprise at least two teeth set at a fixed pitch relative to each other.

7. The variable circumference sprocket of claim 1, in which chain support sections comprise one or more variable position sprocket rim sections with a first end a second end, with said first end rotatably attached to sprocket body, and said second end variable in position relative to said axis of rotation.

8. The variable circumference sprocket of claim 1, in which said toothed sprocket sections are attached to at least one end of said sprocket rim sections.

9. The variable circumference sprocket of claim 7, in which said second ends of adjacent pairs of sprocket rim sections are positioned with second ends adjacent to each other and move together away from or toward said axis of rotation, to take up chain slack caused by chain wear.

10. The variable circumference sprocket of claim 9 in which toothed sprocket sections are positioned adjacent to said adjacent first ends of sprocket rim sections.

11. The variable circumference sprocket of claim 9 in which toothed sprocket sections are positioned adjacent to said adjacent second ends of sprocket rim sections.

12. The sprocket of claim 9 in which said toothed sprocket sections are positioned adjacent to adjacent first ends of said sprocket rim sections.

13. The sprocket of claim 1, in which said sprocket body further comprises a hub, with a plurality of spokes attached to said hub and connecting said hub to said sprocket rim.

14. A variable circumference sprocket for engagement with a chain, comprising:
a sprocket body configured to rotate around an axis of rotation, said sprocket body comprising a hub in said sprocket body at said axis of rotation, with a plurality of spokes attached to said hub and connecting said hub to a sprocket rim;
said sprocket rim forming the periphery of said sprocket body, with sprocket rim components comprising a plurality of toothed sections separated by a plurality of non-toothed sections, with each toothed section comprising a plurality of sprocket teeth set at a fixed pitch from adjacent sprocket teeth on said toothed section, with said non-toothed section of said sprocket rim configured to carry said chain, with at least some of said sprocket rim components movable away from or towards said axis of rotation, to change the circumference of said sprocket.

15. The variable circumference sprocket of claim 14, in which said toothed sections are attached to said spokes and variable in position in relation to said hub, thereby allowing the circumference of said sprocket to be variable without changing the pitch between sprocket teeth.

16. The variable circumference sprocket of claim 14, in which said toothed sections are attached to said spokes and at least one of said non-toothed sections of said sprocket rims is variable in position in relation to said hub, thereby allowing the circumference of said sprocket to be variable without changing the pitch between sprocket teeth.

17. The variable circumference sprocket of claim 14, in which said sprocket rim sections have a first end and a second end, each with a first end rotatably attached to said sprocket rim, and a second end variable in position relative to said axis of rotation, for changing the circumference of said sprocket.

18. The variable circumference sprocket of claim 14, in which said sprocket rim sections ends are attached to said sprocket body adjacent to said spokes.

19. The variable circumference sprocket of claim 14, in which said toothed sprocket sections are attached adjacent to at least one end of said sprocket rim sections.

20. The variable circumference sprocket of claim 14, in which sprocket rim sections are attached to said sprocket body with said second end of one sprocket rim section mounted adjacent to another second end of an adjacent sprocket rim, forming a pair of second ends, configured so that said pair of second ends can move together away from or toward said axis of rotation, to change the circumference of said sprocket, and thus to take up chain slack. Regardless of cause, initial or wear.

21. The sprocket of claim 20 in which toothed sprocket sections are positioned adjacent to said adjacent first ends of sprocket rim sections.

22. The sprocket of claim 20 in which toothed sprocket sections are positioned adjacent to said adjacent second ends of sprocket rim sections.

23. The sprocket of claim 20 in which toothed sprocket sections are positioned adjacent to said adjacent second ends and also adjacent to said first ends of sprocket rim sections.

24. The drive sprocket of claim 14, in which each of said toothed sections comprise a plurality of teeth set at a fixed pitch from adjacent sprocket teeth on said toothed section.

25. The drive sprocket of claim 14 in which at least one of said toothed sections adjust positions by moving away from or toward said hub, thereby changing the circumference of said sprocket.

26. A variable circumference drive sprocket for engagement with a chain, comprising:
a sprocket body configured to rotate around an axis of rotation, comprising a hub in said sprocket body at said axis of rotation, with a plurality of spokes attached to said hub and connecting said hub to a sprocket rim;
said sprocket rim positioned on the periphery of said sprocket body, comprising a plurality of toothed sections separated by a plurality of non-toothed sections, with each toothed section comprising a plurality of sprocket teeth set at a fixed pitch from adjacent sprocket teeth on said toothed section, with said sprocket rim configured to carry said chain, with at least some of said non-toothed sections movable away from or towards said axis of rotation;
with each of said non-toothed sections having a first end rotatably attached to said sprocket body and a second end adjustably attached to said sprocket body, with said non-toothed sections attached to said sprocket body with said second end of one non-toothed section mounted adjacent to a second end of an adjacent sprocket rim, forming a pair of second ends, configured so that said pair of second ends can move together away from or toward said axis of rotation, to change the circumference of said sprocket, and thus to take up chain slack caused by chain wear without changing the pitch between sprocket teeth.
